(19) United States
(12) Patent Application Publication
(10) Pub. No.: US 2017/0175034 A1
(43) Pub. Date: Jun. 22, 2017

(54) CANDLE ASSEMBLY AND METHOD FOR MAKING PERSONALIZED CANDLES

(71) Applicant: Andrea Schroder, Topanga, CA (US)

(72) Inventor: Andrea Schroder, Topanga, CA (US)

(21) Appl. No.: 15/176,062

(22) Filed: Jun. 7, 2016

Related U.S. Application Data
(63) Continuation-in-part of application No. 14/973,566, filed on Dec. 17, 2015.

(51) Int. Cl. C11C 5/02; B23B 51/04; C11C 5/00

(52) U.S. Cl. CPC C11C 5/028; C11C 5/008; C11C 5/006; C11C 5/002; B23B 51/0406; B23B 2251/52; B23B 2260/104

(57) ABSTRACT

A candle assembly for making a personalized scented candle including a candle body comprises a coring device that is configured to remove a core from the candle body, the coring device including (i) a leading edge that selectively extends into the candle body; and (ii) a plurality of measurement markers that measure a depth of the leading edge within the candle body. The coring device can be configured to remove the core from the candle body to form a cavity in the candle body. Additionally, the measurement markers can be utilized to determine a depth of the cavity formed in the candle body by the coring device.

### RELATED APPLICATION

The present application is a continuation-in-part application and claims the benefit under 35 U.S.C. 120 on co-pending U.S. patent application Ser. No. 14/973,566, filed on Dec. 17, 2015, and entitled “CANDLE ASSEMBLY AND METHOD FOR MAKING PERSONALIZED CANDLES”. To the extent permitted, the contents of U.S. patent application Ser. No. 14/973,566 are incorporated herein by reference.

### BACKGROUND

Scented candles have become a popular way to create a desired mood or ambience in any given environment. Scented candles are typically formed with a scented material being added to the wax of the candle during the manufacturing process. The candle then releases the scent during the burning of the candle. Unfortunately, consumers are limited to whatever specific scents and scent concentrations that are generated by the manufacturer. Accordingly, it is desired to enable the consumers to generate their own personalized scented candles so that they can create their own desired mood or ambience.

### SUMMARY

The present invention is directed toward a candle assembly for making a personalized scented candle. The personalized scented candle includes a candle body. In various embodiments, the candle assembly comprises a coring device that is configured to remove a core from the candle body, the coring device including (i) a leading edge that selectively extends into the candle body; and (ii) a plurality of measurement markers that measure a depth of the leading edge within the candle body.

In some embodiments, the coring device removes the core from the candle body to form a cavity in the candle body. In such embodiments, the measurement markers can be utilized to determine a depth of the cavity formed in the candle body by the coring device. Additionally, the coring device can be configured to retain the core from the candle body. In some such embodiments, at least a portion of the coring device is transparent so that the core from the candle body is visible relative to the measurement markers. Additionally and/or alternatively, in other embodiments, at least a portion of the coring device is open so that the core from the candle body is visible relative to at least one of the measurement markers.

In certain embodiments, the coring device includes a first coring member and a second coring member that fits substantially within and moves relative to the first coring member. As above, the coring device can be configured to remove the core from the candle body to form a cavity in the candle body. In some embodiments, the second coring member is configured to receive and retain the core from the candle body. Further, in some such embodiments, the coring device further includes a sealer that is positioned substantially between the first coring member and the second coring member to seal the area between the first coring member and the second coring member.

Additionally, in various embodiments, the candle body includes a wick. In some such embodiments, the coring device forms the cavity in the candle body substantially parallel to the wick. Alternatively, the coring device can form the cavity in the candle body at an angle relative to the wick. Further, the coring device can form the cavity in the candle body spaced apart from the wick and/or the coring device can form the cavity in the candle body to substantially encircle the wick.

Moreover, in some embodiments, the leading edge is curved so as to better enable the leading edge to extend into the candle body.

The present invention is further directed toward a method for making a personalized scented candle, the method comprising (i) extending a leading edge of a coring device into a candle body; (ii) measuring a depth of the leading edge within the candle body with a plurality of measurement markers that are included on a surface of the coring device; and (iii) removing a core from the candle body with the coring device.

### BRIEF DESCRIPTION OF THE DRAWINGS

FIG. 1A is a simplified perspective view illustration of an embodiment of a candle assembly having features of the present invention, the candle assembly including a candle body, a coring device, a plug, and one or more scent retainers;

FIG. 1B is a simplified perspective view illustration of a portion of the candle assembly in FIG. 1A, with a portion of the coring device being positioned within the candle body;

FIG. 1C is a simplified perspective view illustration of the portion of the candle assembly in FIG. 1B, with a cavity having been formed in the candle body with the coring device;

FIG. 1D is a simplified perspective view illustration of another portion of the candle assembly in FIG. 1A, with a scent retainer being utilized to add a scented material into the cavity in the candle body;

FIG. 1E is a simplified perspective view illustration of still another portion of the candle assembly in FIG. 1A, with the plug being positioned to extend into the cavity in the candle body;

FIG. 2A is a simplified perspective view illustration of another embodiment of the candle assembly, the candle assembly including a candle body and a plug that is in a first position;

FIG. 2B is a simplified perspective view illustration of the candle assembly in FIG. 2A, with the plug in a second position;

FIG. 3A is a simplified perspective view illustration of still another embodiment of the candle assembly, the candle assembly including a candle body and a wax insert that is in a first position;

FIG. 3B is a simplified perspective view illustration of the candle assembly in FIG. 3A, with the wax insert in a second position;

FIG. 4 is a simplified perspective view illustration of yet another embodiment of the candle assembly;

FIG. 5 is a simplified perspective view illustration of still another embodiment of the candle assembly;

FIG. 6 is a simplified perspective view illustration of but another embodiment of the candle assembly;

FIG. 7 is a simplified perspective view illustration of still another embodiment of the candle assembly;

FIG. 8 is a simplified perspective view illustration of yet another embodiment of the candle assembly;

FIG. 9A is a simplified perspective view illustration of but another embodiment of the candle assembly, the candle assembly including a candle body and a wicked plug that is in a first position;

FIG. 9B is a simplified perspective view illustration of the candle assembly in FIG. 9A, with the wicked plug in a second position;

FIG. 10 is a simplified perspective view illustration of another embodiment of the coring device;

FIG. 11 is a flowchart that illustrates one embodiment of a method for making a personalized scented candle; and

FIG. 12 is a simplified top view of an embodiment of a cover that can be used as part of the candle assembly in FIG. 1A.

### DESCRIPTION

Embodiments of the present invention are described herein in the context of a candle assembly and method for making a personalized scented candle. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

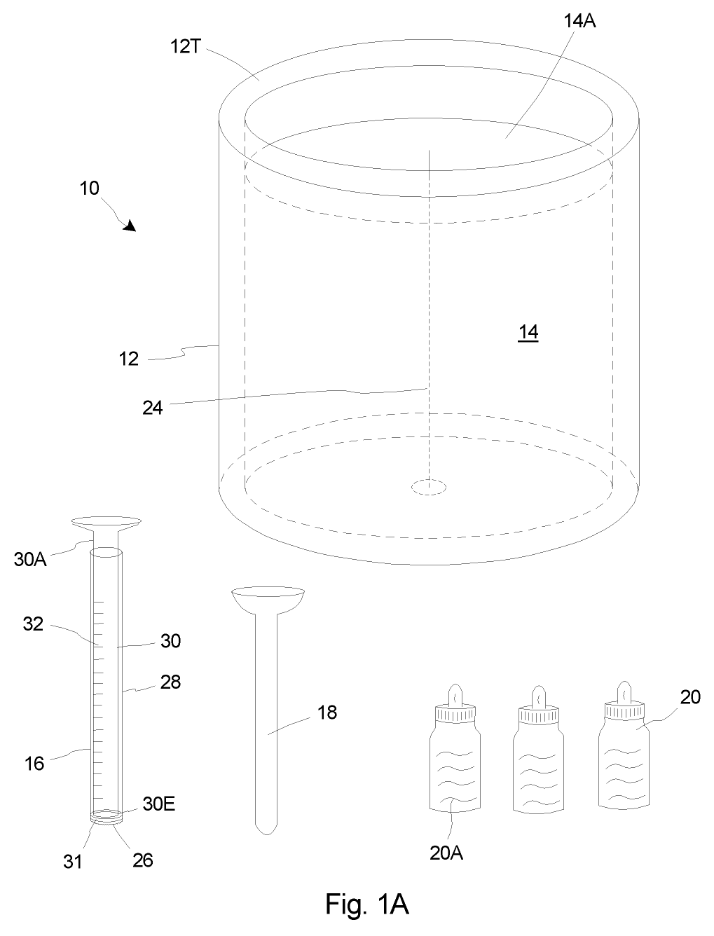

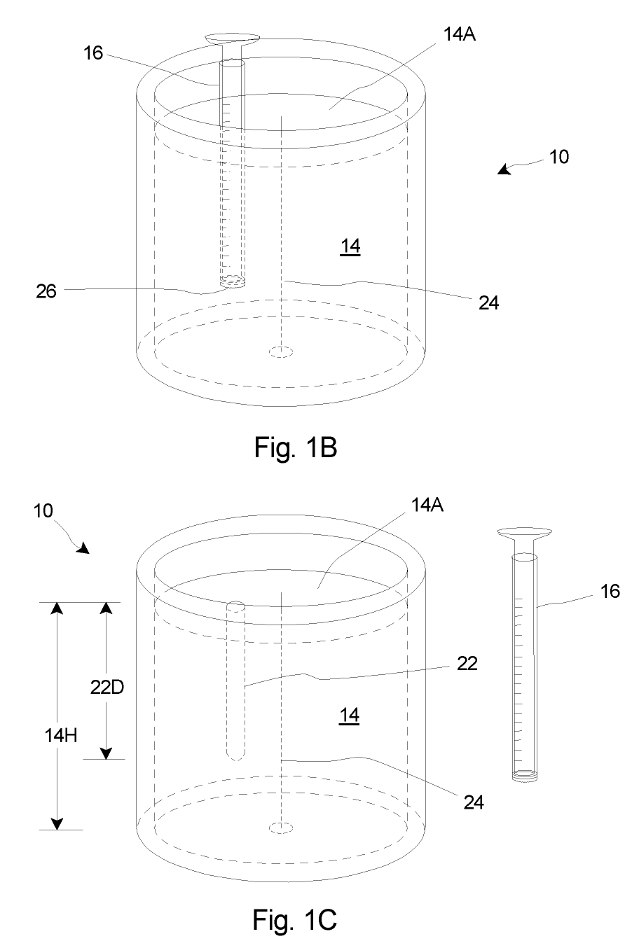

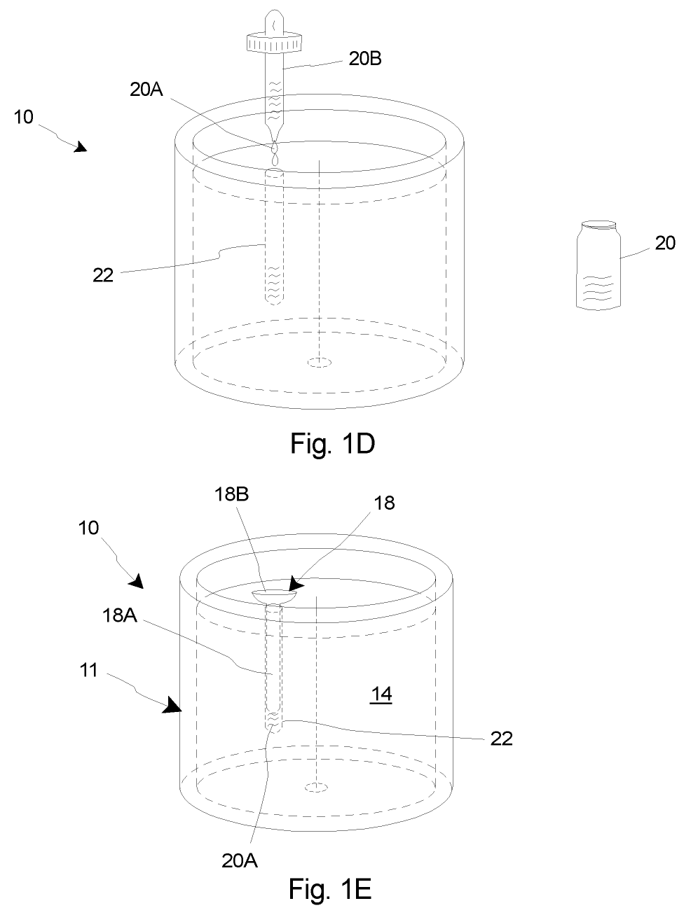

FIG. 1A is a simplified perspective view illustration of an embodiment of a candle assembly 10 having features of the present invention. More specifically, as shown, the candle assembly 10 can be utilized to create a personalized scented candle 11 (illustrated in FIG. 1E, and sometimes referred to herein simply as the “candle”). The design of the candle assembly 10 can be varied. As shown in FIG. 1A, the candle assembly 10 can include a container 12, a candle body 14, a coring device 16, a plug 18, and one or more scent retainers 20 (three scent retainers 20 are illustrated in FIG. 1A). Alternatively, the candle assembly 10 can have any other suitable design. For example, the candle assembly 10 can include more components or fewer components than those specifically illustrated and described with respect to FIG. 1A without departing from the intended scope and breadth of the present invention. In certain non-exclusive alternative embodiments, the candle assembly 10 can omit the container 12 so that the candle body 14 can be a stand-alone candle body 14.

As described in detail herein, the candle assembly 10 allows a user (not shown) to create their own personalized scented candle 11 by creating their own scent mixture from scented materials 20A, e.g., scented fluids, retained within the one or more scent retainers 20, and adding the scent mixture directly into a cavity 22 (illustrated in FIG. 1C) that has been formed into the candle body 14.

The design of the container 12 can be varied. In certain embodiments, the container 12 can have a substantially circular-shaped cross section with an open top edge 12T that allows access to an interior of the container 12. Alternatively, the container 12 can have another suitable design. For example, the container 12 can have a cross-sectional shape that is substantially square-shaped, rectangle-shaped, or any other suitable shape.

Additionally, the container 12 can be formed from any suitable materials. For example, in one embodiment, the container 12 is formed from glass, which can be clear and transparent, and/or can be of any desired colors. Alternatively, the container 12 can be formed from ceramics, metals, or other suitable materials.

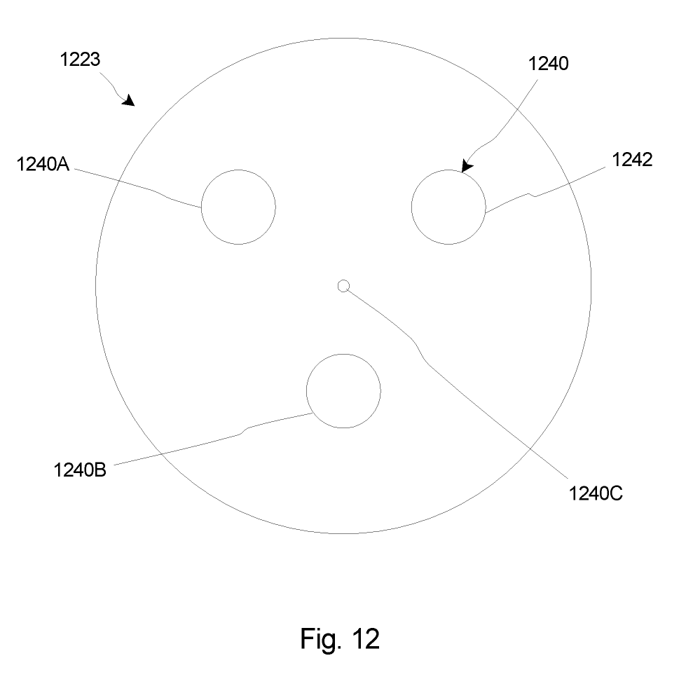

Further, in some embodiments, the candle assembly 10 can include a lid or cover 1223 (illustrated, for example, in FIG. 12). In certain embodiments, the cover 1223 can be configured to be placed over the top edge 12T of the container 12, e.g., when not in use. Additionally and/or alternatively, the cover 1223 can fit down into the container 12 so as to rest on top of the candle body 14. With such design, the cover 1223 can inhibit dust or other particles from settling on top of the candle body 14. Still alternatively, the cover 1223 can have another suitable design.

It is appreciated that different embodiments of the candle assembly 10 can include more than one container 12, which may or may not be of different sizes and shapes.

The candle body 14 can be sized and shaped to fit snugly within the container 12. For example, in certain embodiments, the candle body 14 can be formed from a molten wax material, e.g., paraffin wax, beeswax or other suitable wax material, that is poured into the container 12 and allowed to cool. Alternatively, the candle body 14 can be formed in another molding process. Additionally, the candle body 14 can include dies so that the candle body 14 can be formed in any desired color. Still alternatively, the candle body 14 can be formed from another suitable body material and/or the candle body 14 can be formed via another suitable process.

As provided herein, the candle body 14 can be provided in an unscented form to enable the users to create their own personalized scent to be released. Alternatively, the candle body 14 can be provided in a scented form that can be augmented or altered by any of the devices and/or methods described herein.

It should also be appreciated that the candle assembly 10 can include a plurality of candle bodies 14, which can each be of any desired size and shape, to enable the user to create a plurality of personalized scented candles 11.

Further, in the embodiment illustrated in FIG. 1A, a wick 24 can be positioned substantially centrally within the candle body 14. Additionally, as shown, the wick 24 can be positioned to extend slightly above a top surface 14A of the candle body 14. With such design, the user can have easy access to the wick 24 when the user wants to use his or her personalized scented candle 11. In alternative embodiments, more than one wick 24 can be positioned within the candle body 14 and/or the wick(s) 24 can be positioned at any desired location within the candle body 14. Still alternatively, the wick 24 can be included as part of the plug 18 that is selectively positioned to extend into the candle body 14, e.g., into the cavity 22 formed in the candle body 14.

The coring device 16 is adapted to be directed and selectively extend into the candle body 14, e.g., through the top surface 14A of the candle body 14, in order to form one or more cavities 22 in the candle body 14. The design of the coring device 16 can be varied. In certain embodiments, as shown in FIG. 1A, the coring device 16 has a sharp, leading edge 26 that is able to cut, penetrate or otherwise move into or through the candle body 14 in order to form the desired one or more cavities 22. Additionally, in some embodiments, the leading edge 26 can be substantially curved and/or circular in shape and the coring device 16 can be twisted and/or turned as the coring device 16 is pushed into the candle body 14. By twisting and/or turning the coring device 16 in such a manner, the coring device 16 can more easily cut into the candle body 14 to form the desired one or more cavities therein.

Further, in this embodiment, the coring device 16 includes a first (outer) coring member 28 and a second (inner) coring member 30. The second coring member 30 can fit substantially within the first coring member 28 and move relative to the first coring member 28. It is recognized that either coring member 28, 30 or both coring members 28, 30 can incorporate a sharp, leading edge 26 to cut into the candle body 14.

The coring device 16, i.e. the coring members 28, 30, can have any suitable shape and thus be able to form cavities 22 of any suitable shape within the candle body 14. For example, one or both of the coring members 28, 30 can be substantially cylindrical or tube-shaped to form substantially cylindrically-shaped cavities 22 within the candle body 14. Alternatively, one or both of the coring members 28, 30 can have another suitable shape to form cavities 22 of another suitable shape.

Additionally, as illustrated in FIG. 1A, in certain embodiments, the coring device 16 can further include a sealer 31, e.g., a resilient O-ring or other suitable design, that is positioned at least substantially between the first coring member 28 and the second coring member 30. For example, the sealer can include a rubber material (or other resilient material) that is substantially toroidal-shaped, or another suitable shape that generates a suction or creates a vacuum within the coring device 16 during use. In some such embodiments, the sealer 31 can be secured to the second coring member 30 near a leading edge 30E of the second coring member 30. Thus, the sealer 31 will move with the second coring member 30 when the second coring member 30 is moved relative to, i.e. within, the first coring member 28. Alternatively, the sealer 31 can be positioned in a different manner relative to the first coring member 28 and/or the second coring member 30. Still alternatively, the coring device 16 can be designed without the sealer 31.

As shown, the sealer 31 is positioned to seal the area between the first coring member 28 and the second coring member 30. Moreover, the sealer 31 is configured to create suction and/or a vacuum within the coring device 16, to more effectively promote that the desired portion of the candle body 14, i.e. the desired core of material, is removed during the formation of the one or more cavities 22.

Further, as shown, the coring device 16 includes a plurality of measurement markers 32, which can be in the form of lines, notches, or any other suitable type of markers. The measurement markers are configured to measure a distance that the leading edge 26 extends into the candle body 14. Further, the measurement markers 32 can also be utilized to determine and/or demonstrate the depth of any cavity 22 that is being formed by the coring device 16. More particularly, in the embodiment illustrated in FIG. 1A, when a core of material, e.g., wax material, is removed from the candle body 14 during the formation of the cavity 22, the core of material will be received and retained within the second (inner) coring member 30. In certain embodiments, the measurement markers 32 are provided along a surface 30A, e.g., an outer surface, of the second coring member 30 so that the user can see the amount of wax material in the second coring member 30 and thus determine the depth of the cavity 22. Additionally and/or alternatively, the measurement markers 32 can be provided along a surface of the first (outer) coring member 28.

Additionally, in some embodiments, the coring members 28, 30 can be substantially transparent to enable the user (illustrated in FIG. 1E) to easily determine the depth of the cavity 22 by the amount of wax material removed and retained within the second coring member 30.

As provided herein, it is appreciated that the coring device 16 can be used at any time to form or reform cavities 22 within the candle body 14. For example, the coring device 16 can be used to form one or more cavities 22 before (or during) the first use, to reform the one or more cavities 22 between (or during) uses, and/or to form one or more new cavities 22 between (or during) uses of the candle 11.

The plug 18 selectively extends into the cavity 22. For example, the plug 18 can be positioned to extend into the cavity 22 to inhibit the cavity 22 from closing up when the candle 11 is not in use. In particular, the plug 18 can function to keep the cavity 22 expanded during heat/cold, storage, etc. so that the cavity 22 does not seal itself in an undesired manner. Additionally, as provided herein, one or more scented materials 20A can be added into the cavity 22 in any desired combination so that a user can create his/her own personalized scented candle 11. As such, the plug 18 can also function to inhibit any evaporation of the scented materials 20A when the candle 11 is not in use. Alternatively, in some embodiments, the plug 18 can include and/or be infused with scented materials 20A such that the plug 18 can remain within the cavity 22 during the use, i.e. the burning, of the personalized scented candle 11.

The plug 18 can be formed from any suitable material. For example, in various embodiments, the plug 18 can be formed from silicon, wood, cork, plastic, wax, or other suitable materials.

As noted above, the one or more scent retainers 20 can each retain a scented material 20A, e.g., a scented fluid, that can be selectively added into the cavity 22 by the user. Although FIG. 1A illustrates three scent retainers 20 as part of the candle assembly 10, it is appreciated that the candle assembly 10 can include any desired number of scent retainers 20 and, thus, any desired number of scented materials 20A. Additionally, it is also appreciated that the scented materials 20A can be added individually into the cavity 22, or the scented materials 20A can be combined into any desired scent mixture outside of the candle body 14 and then added collectively into the cavity 22.

FIG. 1B is a simplified perspective view illustration of a portion of the candle assembly 10 in FIG. 1A. In particular, FIG. 1B illustrates the coring device 16 being positioned substantially within the candle body 14 for purposes of forming the cavity 22 (illustrated in FIG. 1C).

In this embodiment, the coring device 16 is directed generally straight downward into the candle body 14, albeit with the possibility of having been twisted and turned during the process as noted above. As shown, the coring device 16 can be initially directed into the top surface 14A of the candle body 14, with the sharp, leading edge 26 cutting, penetrating or otherwise moving into and/or through the wax material that forms the candle body 14. Alternatively, the coring device 16 can be directed into the candle body 14 other than generally straight downward. For example, in one non-exclusive alternative embodiment, the coring device 16 can be directed into the candle body 14 at an angle.

Additionally, as shown, the coring device 16 is directed into the candle body spaced apart from the wick 24. Alternatively, the coring device 16 can be directed into the candle body 14 such that the cavity 22 is formed to substantially encircle or surround the wick 24.

FIG. 1C is a simplified perspective view illustration of the portion of the candle assembly 10 in FIG. 1B, with the cavity 22 having been formed in the candle body 14 with the coring device 16. In particular, as shown, the cavity 22 is substantially vertical in orientation as it extends downward from the top surface 14A of the candle body 14 substantially parallel to and spaced apart from the wick 24. Alternatively, the cavity 22 can be other than substantially vertical and/or the cavity 22 can be formed to substantially surround the wick 24. For example, as provided herein, in certain non-exclusive alternative embodiments, the cavity 22 can be formed at an angle relative to the candle body 14 and the wick 24 and/or the cavity 22 can be curved as it extends downward into the candle body 14 from the top surface 14A.

The cavity 22 can be any suitable cross-sectional size and shape. Additionally, the cavity 22 can extend any desired distance downward into the candle body 14 to get the desired distribution of scented materials 20A (illustrated in FIG. 1A) into the candle body 14, i.e. so that the scented materials 20A can be substantially consistently released during the full burning of the candle 11 (illustrated in FIG. 1E). For example, in some embodiments, the cavity 22 can have a depth 22D that extends between approximately fifty percent and eighty percent of a height 14H of the candle body 14. Alternatively, the cavity 22 can have a depth 22D of greater than eighty percent or less than fifty percent of the height 14H of the candle body 14.

FIG. 1D is a simplified perspective view illustration of another portion of the candle assembly 10 in FIG. 1A. More specifically, FIG. 1D illustrates the scented material 20A from one of the scent retainers 20 being added into the cavity 22 in the candle body 14. In this embodiment, the scented materials 20A are being added into the cavity 22 with an eyedropper 20B that is selectively coupled to and provides a lid for the scent retainer 20. Alternatively, the scented materials 20A can be added into the cavity 22 in another suitable manner.

It is appreciated that any desired amount of scented materials 20A can be added into the cavity 22 depending on the desired strength of scent to be provided by the candle 11 (illustrated in FIG. 1E). For example, only a small amount of scented materials 20A can be added if a lightly scented candle 11 is desired. Additionally, a moderate amount of scented materials 20A can be added if the user (illustrated in FIG. 1E) wants the candle 11 to emit a medium strength scent. Further, a greater amount of scented materials 20A can be added if a strongly scented candle 11 is desired.

FIG. 1E is a simplified perspective view illustration of still another portion of the candle assembly 10 in FIG. 1A. Moreover, FIG. 1E can also be noted as illustrating the personalized scented candle 11 that has been created by the user.

In FIG. 1E, the plug 18 has been positioned to extend into the cavity 22 in the candle body 14. As noted, the plug 18 can be used to maintain the integrity of the cavity 22 when the candle 11 is not in use, i.e. to inhibit the cavity 22 from sealing up. Additionally, the plug 18 can further inhibit any scented materials 20A that have already been added to the cavity 22 from evaporating.

The plug 18 can be of any suitable size and can extend any desired distance down into the cavity 22. Additionally, in this embodiment, the plug 18 includes a shaft 18A and a handle 18B. The shaft 18A of the plug 18 is sized to extend any desired distance down into the cavity 22. Further, the handle 18B can be somewhat larger in cross-sectional size as compared to the shaft 18A. The handle 18B can be configured to be easily grasped by the user in order to selectively position the plug 18 into the cavity 22 and to selectively remove the plug 18 from the cavity 22.

Herein below, various alternative embodiments for the candle assembly 10 will be illustrated and described. It should be appreciated that certain components of the alternative candle assemblies may not be illustrated when such components are substantially identical to the components illustrated with the candle assembly 10 illustrated in FIG. 1A. For example, such alternative embodiments may again include the one or more scent retainers 20 for retaining the desired scented materials 20A, the coring device 16 and/or the plug 18, even though such components are not illustrated in the Figures. Additionally, it is appreciated that any components from any of the described embodiments can be combined with components from any of the other embodiments to form even more embodiments provided that such combination is logical and satisfies the intent of the present invention.

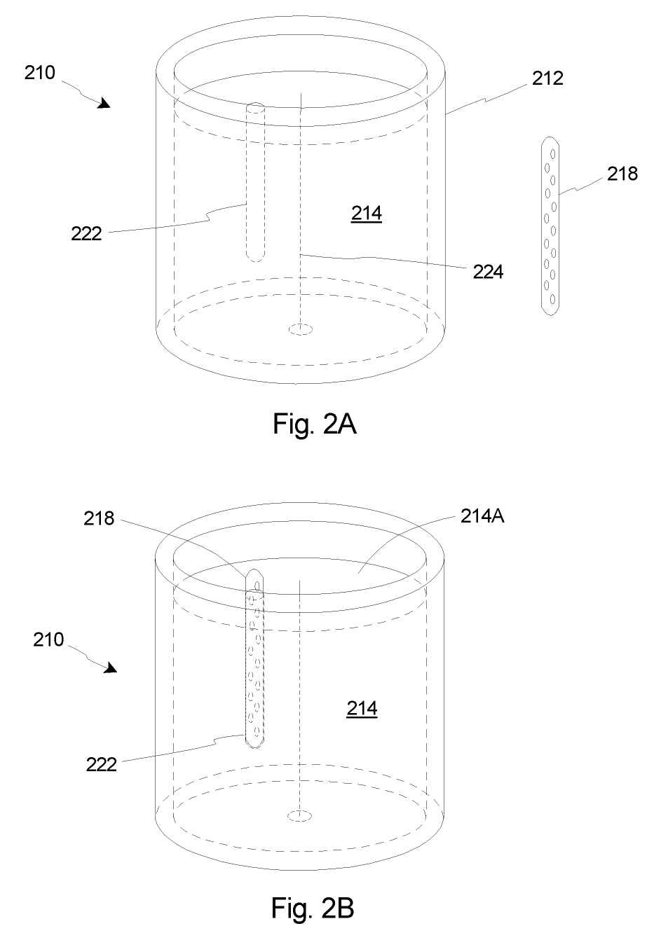

FIG. 2A is a simplified perspective view of another embodiment of the candle assembly 210. In this embodiment, the candle assembly 210 is somewhat similar to the previous embodiment. For example, as shown, the candle assembly 210 again includes the container 212 and the candle body 214 that are substantially similar to the previous embodiment. Additionally, the cavity 222 that has been formed into the candle body 214 is again substantially vertical and spaced apart from the single wick 224.

However, in this embodiment, the plug 218 has a different design. In particular, in this embodiment, the plug 218 is an airy plug that can be formed from a wax material that includes air cavities or channels throughout the plug 218 that enable one or more scented materials 20A (illustrated in FIG. 1A) from the scent retainers 20 (illustrated in FIG. 1A) to be directly added to and/or infused into the plug 218. With such design, the plug 218 can act like a sponge that readily absorbs any scented materials 20A, e.g., liquid scented materials, that may be dropped onto the plug 218.

It is appreciated that (i) the desired scented materials 20A can be added into the plug 218 before the plug 218 is positioned in the cavity 222, i.e. with the plug 218 in a first position outside of the cavity 222, or (ii) the desired scented materials 20A can be added into the plug 218 after the plug 218 has been positioned within the cavity 222, i.e. with the plug 218 in a second position within the cavity 222 (as shown in FIG. 2B).

FIG. 2B is a simplified perspective view of the candle assembly 210 in FIG. 2A, with the plug 218 in the second position, i.e. with the plug 218 positioned within the cavity 222 formed in the candle body 214. As shown, in this embodiment, the plug 218 can extend slightly above the top surface 214A of the candle body 214, e.g., by one-eighth of an inch, so that the user (illustrated in FIG. 1E) can better recognize where the desired scented materials 20A (illustrated in FIG. 1A) can be added. In one non-exclusive embodiment, the scented materials 20A can be added into the airy plug 218 with a syringe-type injector. Alternatively, the scented materials 20A can be added with the use of the eyedropper 20B (illustrated in FIG. 1D), and the scented materials can be readily absorbed by the plug 218, as described above. Still alternatively, the scented materials 20A can be added through another suitable method.

In some embodiments, the airy plug 218 can be positioned within the container 212 first and then the candle body 214 can be formed about the airy plug 218. In such embodiments, no cavities necessarily need to be specifically formed within the candle body 214. However, it is appreciated that the coring device 16 (illustrated in FIG. 1A) can still utilized to subsequently form one or more cavities within the candle body 214 for the potential addition of more scented materials 20A.

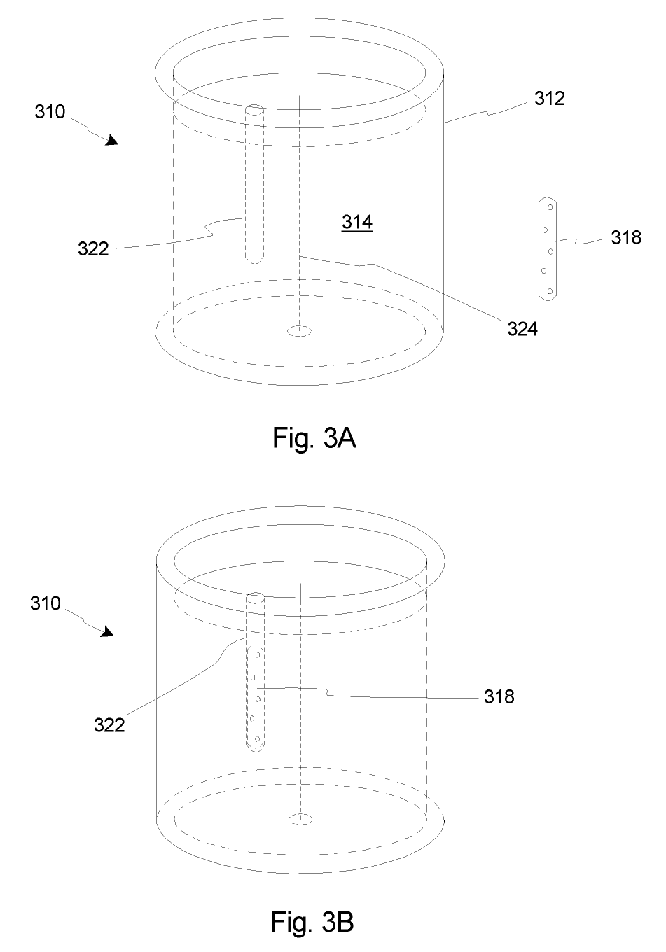

FIG. 3A is a simplified perspective view of still another embodiment of the candle assembly 310. As shown, the candle assembly 310 again includes the container 312 and the candle body 314 that are substantially similar to the previous embodiments. Additionally, as with the previous embodiments, a single cavity 322 has again been formed in the candle body 314, e.g., with the coring device 16 (illustrated in FIG. 1A), that is substantially vertical and parallel to and spaced apart from the single wick 324.

However, in this embodiment, the plug 318 is provided in the form of a wax insert that has certain features in common with the plug 218 illustrated in FIG. 2A. For example, the wax insert 318 can selectively receive and retain any desired scented materials 20A (illustrated in FIG. 1A) that the user (illustrated in FIG. 1E) may want to add to their candle 11 (illustrated, for example, in FIG. 1E). The wax insert 318 is configured to be selectively positioned within the cavity 322 prior to use, i.e. prior to burning, of the candle 11. In FIG. 3A, the wax insert 318 is shown in a first position outside of the cavity 322.

FIG. 3B is a simplified perspective view of the candle assembly 310 in FIG. 3A. Additionally, as illustrated, the wax insert 318 is now in a second position within the cavity 322. In certain embodiments, as shown, the wax insert 318 can be smaller than the depth 22D (illustrated in FIG. 1C) of the cavity 322 to be easily sealed within the cavity 322 once the candle 11 (illustrated, for example, in FIG. 1E) has been lit.

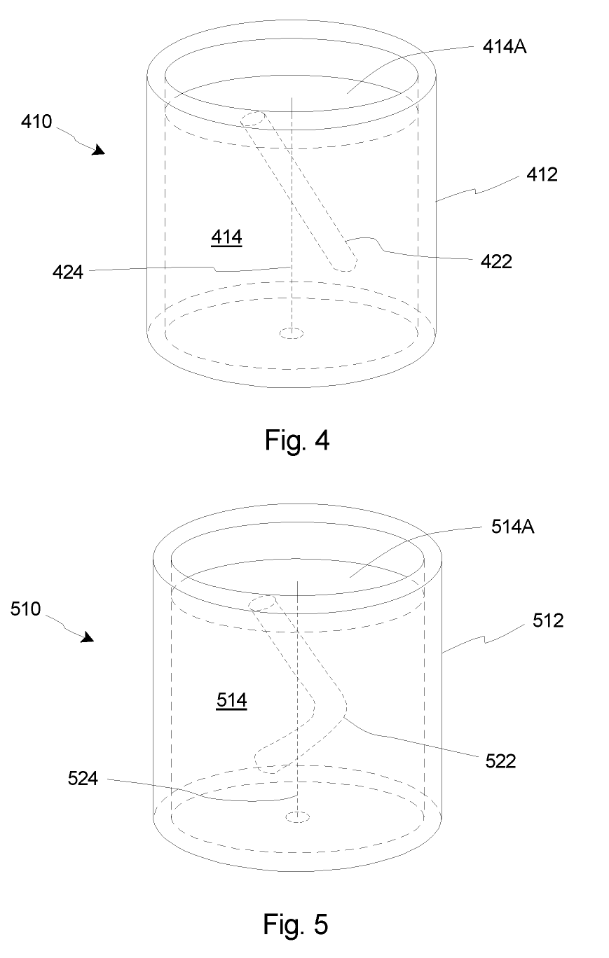

FIG. 4 is a simplified perspective view of yet another embodiment of the candle assembly 410. The candle assembly 410 again includes a container 412 and a candle body 414 that can be substantially similar to the previous embodiments. However, in this embodiment, the cavity 422 extends from the top surface 414A of the candle body 414 downward at an angle into the candle body 414. It is appreciated that the cavity 422 can extend down to any desired depth and the cavity 422 can extend downward into the candle body 414 at any desired angle. For example, in certain non-exclusive embodiments, the cavity 422 can extend at an angle of between approximately twenty degrees and seventy degrees relative to the wick 424.

FIG. 5 is a simplified perspective view of still another embodiment of the candle assembly 510. As shown, the candle assembly 510 again includes a container 512 and a candle body 514 that can be substantially similar to the previous embodiments. However, in this embodiment, the cavity 522 is curved as it extends downward from the top surface 514A of the candle body 514 and into the candle body 514. It is appreciated that the curved cavity 522 can have any suitable design. Additionally, in this embodiment, the curved cavity 522 is spaced apart from the wick 524.

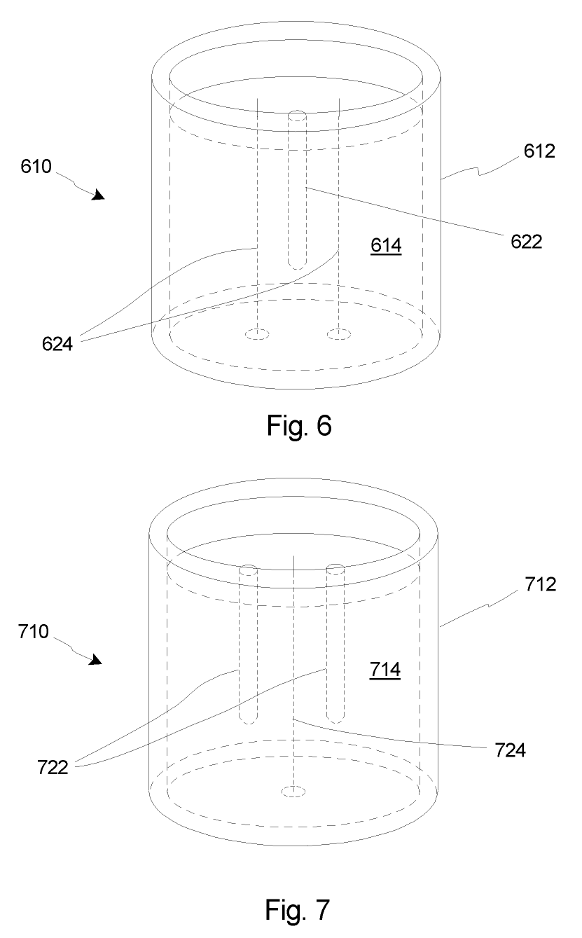

FIG. 6 is a simplified perspective view of yet another embodiment of the candle assembly 610. The candle assembly 610 once again includes the container 612 and the candle body 614 that can be substantially similar to those illustrated in the previous embodiments. However, in this embodiment, two spaced apart wicks 624 are included within the candle body 614, with one cavity 622, e.g., a substantially vertical cavity, being substantially directly between the two wicks 624. In alternative embodiments, it is appreciated that the candle assembly 610 can include any desired number of wicks 624 and any desired number of cavities 622, and the wicks 624 and the cavities 622 can be positioned in any desired manner relative to one another.

FIG. 7 is a simplified perspective view of still another embodiment of the candle assembly 710. As shown, the candle assembly 710 again includes the container 712 and the candle body 714 that can be substantially similar to the previous embodiments illustrated and described above. However, in this embodiment, two spaced apart cavities 722, e.g., substantially vertical cavities, have been formed within the candle body 714, with a single wick 724 positioned therebetween.

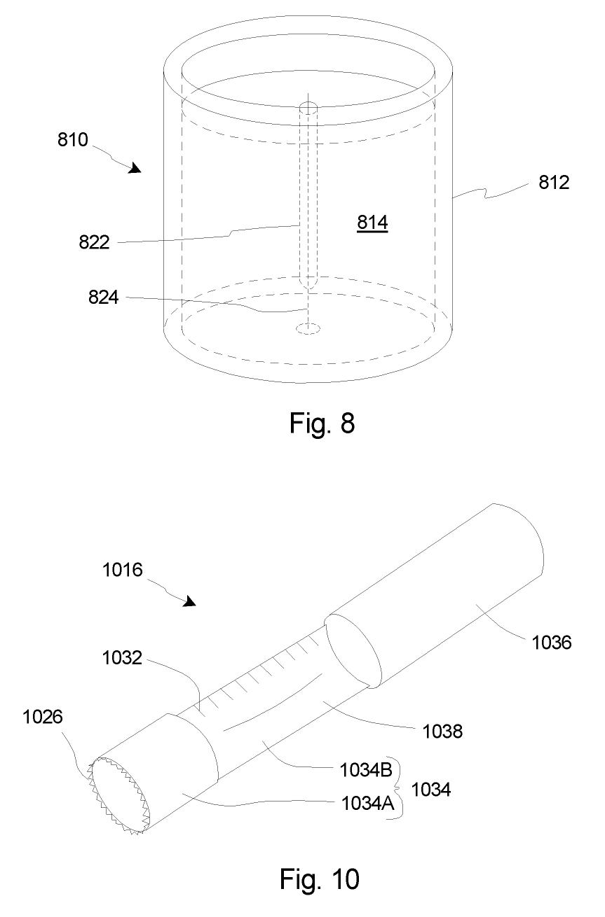

FIG. 8 is a simplified perspective view of yet another embodiment of the candle assembly 810. Once again, as illustrated, the candle assembly 810 includes the container 812 and the candle body 814 that can be substantially similar to what has been illustrated and described in the previous embodiments. However, in this embodiment, the cavity 822 has been formed into the candle body 814, e.g., with the coring device 16 (illustrated in FIG. 1A) to substantially surround and/or encircle the wick 824. In this embodiment, the cavity 822 has effectively created a small bowl-type opening around the wick 824 into which the scented materials (illustrated in FIG. 1A) can be added as desired.

It is appreciated that in such embodiment, it is necessary to ensure that the integrity of the cavity 822 and the positioning of the wick 824 are effectively maintained prior to the adding of scented materials 20A into the cavity 822 and the subsequent lighting of the candle 11 (illustrated, for example, in FIG. 1E). As such, the cavity 822 and/or the wick 824 may be reinforced and/or supported with one or more support components (not shown) to ensure the proper and desired positioning of the wick 824.

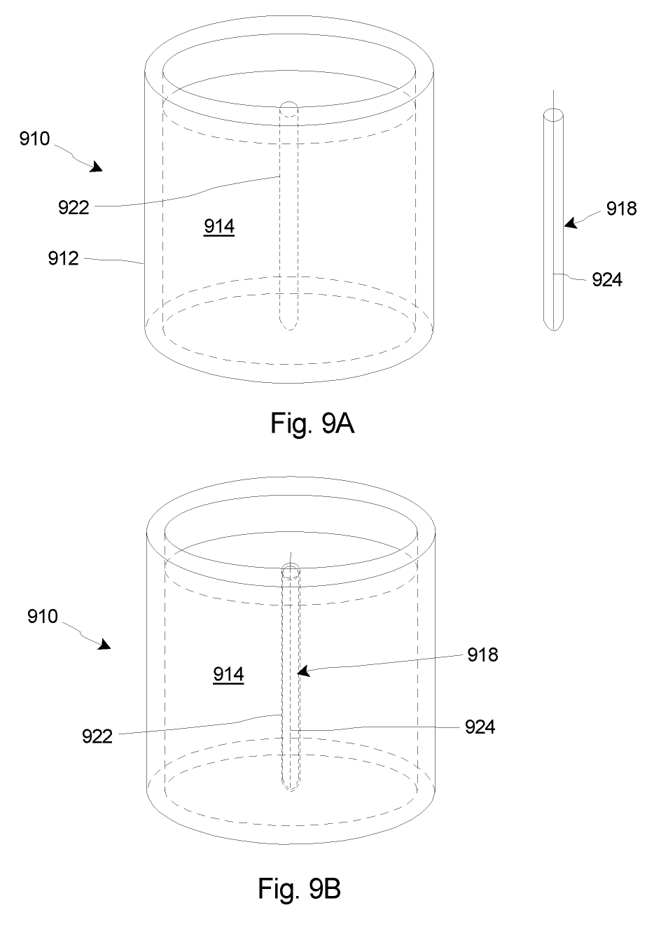

FIG. 9A is a simplified perspective view of still yet another embodiment of the candle assembly 910. As with each of the previous embodiments, the candle assembly 910 can again include the container 912 and the (unscented) candle body 914 that is substantially similar to what has been illustrated and describe in the previous embodiments. Additionally, as shown, a single cavity 922 has been formed into the candle body 914, e.g., with the coring device 16 (illustrated in FIG. 1A). In one embodiment, as illustrated, the cavity 922 can be substantially centrally positioned within the candle body 914. Alternatively, the cavity 922 can be positioned in another suitable location within the candle body 914. Still alternatively, in certain embodiments, the candle body 914 can include more than one cavity 922 without departing from the intended scope and breadth of the present invention.

However, as shown in this embodiment, the candle body 914 is initially formed without a wick. Further, as illustrated, the candle assembly 910 further includes a plug 918 that includes a wick 924 that is embedded therein. As such, the plug 918 in this embodiment can also be referred to as a “wicked plug”. The plug 918 is shown in FIG. 9A in a first position, i.e. outside the candle body 914.

The plug 918 can be formed from any suitable materials. For example, the plug 918 can be formed from any suitable wax material or other material that is substantially similar to the material used to form the candle body 914. Additionally and/or alternatively, the plug 918 can be formed from an airy wax material similar to what was described above with regard to the airy plug 218 illustrated in FIG. 2A. More particularly, in such embodiment, the plug 918 can be formed from a wax material that includes air cavities or channels throughout the plug 918 that enable scented materials 20A (illustrated in FIG. 1A) to be directly added and/or infused into the plug 918.

FIG. 9B is a simplified perspective view of the candle assembly 910 in FIG. 9A. Additionally, as shown, the wicked plug 918 is now in a second position, i.e. with the plug 918 being positioned within the cavity 922 that was formed in the candle body 914. In such position, the wick 924 that was provided within the plug 918 can now be lit as desired.

FIG. 10 is a simplified perspective view of another embodiment of the coring device 1016. In this embodiment, the coring device 1016 includes a first (coring) member 1034 and a second (handle) member 1036 that is coupled to the first member 1034.

As shown in FIG. 10, a sharp leading edge 1026 can be coupled to and/or integrally formed into the first (coring) member 1034. As with the previous embodiment, the leading edge 1026 can be serrated or otherwise sharpened to be able to more easily cut, penetrate or otherwise move into and/or through the candle body 14 (illustrated in FIG. 1A). More particularly, the leading edge 1026 can be used to cut, penetrate or otherwise move into the top surface 14A (illustrated in FIG. 1A) and generally downward into the candle body 14 to form one or more cavities 22 (illustrated in FIG. 1C) therein.

In this embodiment, the first member 1034 includes a substantially cylindrical tube-shaped first portion 1034A which includes and extends distally away from the leading edge 1026, and a curved second portion 1034B that extends between and couples the first portion 1034A and the second (handle) member 1036. In certain embodiments, the curve of the second portion 1034B is substantially similar to the curve of the first portion 1034A, with the exception that at least a portion of the second portion 1034B is open. Stated in another manner, in such embodiment, at least a portion of the first (coring) member 1034 is open (i.e. such portion of the first (coring) member 1034 does not form a complete cylindrical tube shape) to enable the user (illustrated in FIG. 1E) to see the amount of wax material that is being removed with the coring device 1016. Alternatively, at least a portion of the first (coring) member 1034 can be substantially transparent to enable the user to see the amount of wax material that is contained therein.

Further, as illustrated, the coring device 1016 can again include a plurality of measurement markers 1032 along a surface 1038 of the first (coring) member 1034. As with the previous embodiment, the measurement markers 1032 can be utilized to measure the depth of the coring device 1016, i.e. the leading edge 1026, into the candle body 1014. Additionally, the measurement markers 1032 can also be utilized to determine the amount of wax material that is being removed from the candle body 14, and, thus, the depth of the cavity 22 being formed in the candle body 14 with the coring device 1016.

Still further, as with previous embodiments, the coring device 1016 can be designed to include a sealer (not shown), e.g., that can be secured to the first (coring) member 1034 in any desired manner. Alternatively, as shown, the coring device 1016 can be designed without a sealer.

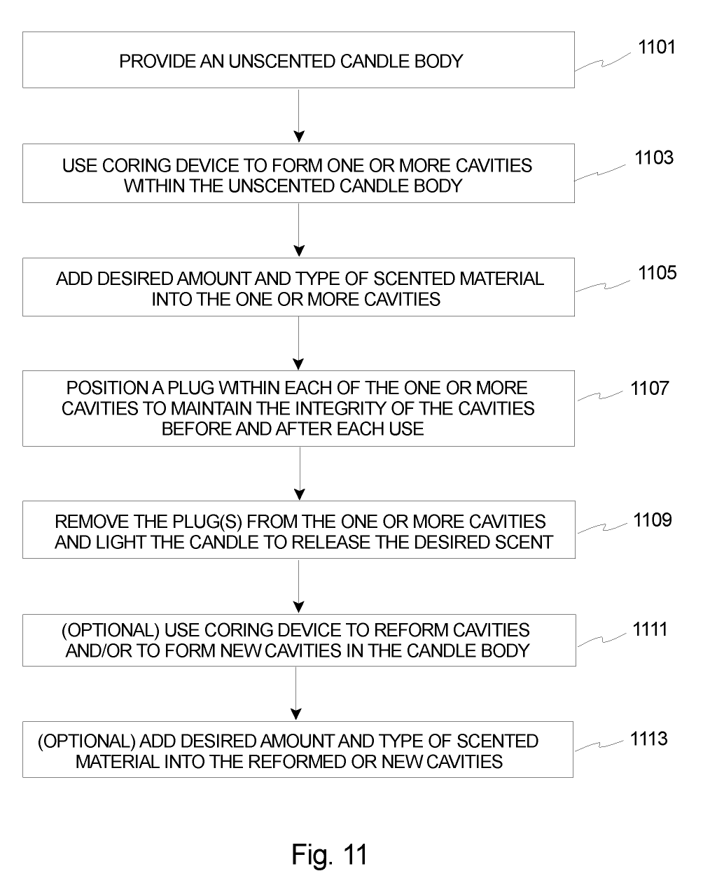

FIG. 11 is a flowchart that illustrates an embodiment of a method for making a personalized scented candle using the candle assembly of FIG. 1A.

It is understood that the various steps described herein can be modified as necessary in the process of making the personalized scented candle. Additionally, it should also be appreciated that in certain applications the order of the steps can be modified, certain steps can be omitted, and/or additional steps can be added without limiting the intended scope and breadth of the present invention.

In step 1101, a user provides an unscented candle body of any desired shape or size. The candle body can be formed of any suitable materials, such as paraffin wax, beeswax, or any other suitable materials. Additionally, the candle body can include any suitable number of wicks. Further, in alternative embodiments, the candle body can be provided within a suitable container or the candle body can be provided as a stand-alone candle body without a container.

In step 1103, a coring device is utilized to remove material from the candle body to form one or more cavities in the unscented candle body. The cavities can be of any suitable size, shape, orientation and overall design. Additionally, the cavities can be spaced apart from any wicks that are provided within the candle body, or a cavity can be formed to substantially surround or encircle any of the wicks.

In step 1105, a desired amount and type of scented material is selectively added to the one or more cavities. As provided herein, the scented material that is added to the cavities can encompass a single scent or any possible combination of scents. Additionally, when a combination of scents is being utilized, the scents can be individually added into the one or more cavities or the desired scents can be combined outside of the candle body and then added collectively into the one or more cavities. In embodiments, that include more than one cavity, the same scent(s) can be added into each cavity or different scent(s) can be added into each cavity.

In step 1107, a plug can be positioned within each of the one or more cavities to maintain the integrity of the cavities, e.g., to inhibit the cavities from sealing, both before and between any uses of the candle. In certain embodiments, steps 1105 and 1107 can be combined such that the scented material is infused within the plug itself, and the positioning of the plug can thus also incorporate the adding of the scented material. Additionally and/or alternatively, in some embodiments, the plug(s) can be positioned within the one or more cavities, and the scented material can be added to or infused within the plug with the plug already being positioned within the cavity.

In step 1109, the plug(s) can be removed from the one or more cavities and the wick(s) of the candle is lit. During the burning of the candle, the scent is released to provide a desired mood or ambience. Additionally, the lighting of the candle can also provide heat which can melt the wax material of the candle body around the wick to seal the one or more cavities so that the scented material is trapped within the cavities. The candle can be used and reused (i.e. the flame can be extinguished and the candle relit) in such a manner any desired number of times. It is recognized that in embodiments wherein the scented material is infused within the plug, either before or after the plug is positioned within the cavity, the plug can be left in the cavity during burning of the candle.

In optional step 1111, the coring device can be used again to reform any of the previous cavities and/or to form one or more new cavities within the candle body.

Additionally, in optional step 1113, more scented material can be added into the reformed or new cavities. Such additional scented material can be substantially the same as or different from the previous scented material that had been added into the one or more cavities. The candle can then be continually used and reused as desired.

FIG. 12 is a simplified top view of an embodiment of a cover 1223 that can be used as part of the candle assembly 10 in FIG. 1A. The design of the cover 1223 can be varied to suit the specific requirements of the candle assembly 10. Additionally, the cover 1223 can be configured and positioned to inhibit dust and other particles from settling onto the candle body 14 (illustrated in FIG. 1A) when the candle assembly 10 is not in use. For example, in some embodiments, as illustrated in FIG. 12, the cover 1223 can be substantially circular-shaped and can be configured to rest substantially directly on top of the top surface 14A (illustrated in FIG. 1A) of the candle body 14.

Additionally, as shown, the cover 1223 can include one or more cover apertures 1240. In certain embodiments, each of the one or more cover apertures 1240 can be positioned in a manner so as to provide a template for the user to form one or more cavities 22 (illustrated in FIG. 1C) into the candle body 14. More specifically, the one or more cover apertures 1240 can be sized and positioned such that appropriate cavities 22 can be formed, which can then be utilized, i.e. filled with scented materials 20A (illustrated in FIG. 1A) to effectively generate a desired scent during use of the candle 11 (illustrated in FIG. 1E).

In the embodiment illustrated in FIG. 12, the cover 1223 includes three cover apertures 1240 that are positioned for the purpose of guiding the user to form three cavities 22 within the candle body 14. With such design, a desired amount of scented materials 20A can then be added into the cavities 22 without removing the cover 1223 from on top of the candle body 14. It should be appreciated, however, that the cover 1223 will typically be removed prior to using, i.e. lighting, the candle 11. In alternative embodiments, the cover 1223 can be designed to include greater than three or fewer than three cover apertures 1240, which can correspond to a desired number of cavities 22 for the user to form into the candle body 14.

Further, the cavities 22 that have been formed can then be utilized to control the level of scent or fragrance that is to be generated by the candle 11 (illustrated in FIG. 1E) during use. For example, in some embodiments, such as shown in FIG. 12, (i) the candle 11 can generate a light fragrance during use when scented materials 20A are only added into one cavity 22, i.e. that has been formed substantially adjacent to a first cover aperture 1240A; (ii) the candle 11 can generate a medium fragrance during use when scented materials 20A are added into two cavities 22, i.e. that have been formed substantially adjacent to the first cover aperture 1240A and a second cover aperture 1240B; and (iii) the candle 11 can generate a high or strong fragrance during use when scented materials 20A are added into three cavities 22, i.e. that have been formed substantially adjacent to each of the first cover aperture 1240A, the second cover aperture 1240B and a third cover aperture 1240C. Alternatively, the level of fragrance that is generated by the candle 11 during use can be controlled in another suitable manner.

Additionally, as shown, the cover 1223 can also include a wick aperture 1242 that is positioned to provide a suitable opening for the wick 24 (illustrated in FIG. 1A) positioned within the candle body 14. It should be appreciated that a greater number of wick apertures 1242 can be included when the candle body 14 includes more than one wick 24. Alternatively, the cover 1223 can be designed without the wick aperture 1242.

It is understood that although a number of different embodiments of the candle assembly 10 and method have been illustrated and described herein, one or more features of any one embodiment can be combined with one or more features of one or more of the other embodiments, provided that such combination satisfies the intent of the present invention.

While a number of exemplary aspects and embodiments of the candle assembly 10 and method have been shown and disclosed herein above, those of skill in the art will recognize certain modifications, permutations, additions and sub-combinations thereof. It is therefore intended that the system and method shall be interpreted to include all such modifications, permutations, additions and sub-combinations as are within their true spirit and scope, and no limitations are intended to the details of construction or design herein shown.

What is claimed is:

1. A candle assembly for making a personalized scented candle, the personalized scented candle including a candle body, the candle assembly comprising:
a coring device that is configured to remove a core from the candle body, the coring device including (i) a leading edge that selectively extends into the candle body; and (ii) a plurality of measurement markers that measure a depth of the leading edge within the candle body.

2. The candle assembly of claim 1 wherein the coring device removes the core from the candle body to form a cavity in the candle body, and wherein the measurement markers are utilized to determine a depth of the cavity formed in the candle body by the coring device.

3. The candle assembly of claim 1 wherein the coring device is configured to removably retain the core from the candle body, and wherein at least a portion of the coring device is transparent so that the core from the candle body is visible relative to the measurement markers.

4. The candle assembly of claim 1 wherein the coring device is configured to removably retain the core from the candle body, and wherein at least a portion of the coring device is open so that the core from the candle body is visible relative to at least one of the measurement markers.

5. The candle assembly of claim 1 wherein the coring device includes a first coring member and a second coring member that fits substantially within and moves relative to the first coring member.

6. The candle assembly of claim 5 wherein the coring device removes the core from the candle body to form a cavity in the candle body, and wherein the second coring member is configured to receive and retain the core of the candle body.

7. The candle assembly of claim 5 wherein the coring device further includes a sealer that is positioned substantially between the first coring member and the second coring member.

8. The candle assembly of claim 1 wherein the candle body includes a wick, and wherein the coring device forms a cavity in the candle body substantially parallel to the wick.

9. The candle assembly of claim 1 wherein the candle body includes a wick, and wherein the coring device forms a cavity in the candle body at an angle relative to the wick.

10. The candle assembly of claim 1 wherein the candle body includes a wick, and wherein the coring device forms a cavity in the candle body spaced apart from the wick.

11. The candle assembly of claim 1 wherein the candle body includes a wick, and wherein the coring device forms a cavity in the candle body to substantially encircle the wick.

12. A method for making a personalized scented candle, the method comprising:
extending a leading edge of a coring device into a candle body;
measuring a depth of the leading edge within the candle body with a plurality of measurement markers that are included on a surface of the coring device; and
removing a core from the candle body with the coring device.

13. The method of claim 12 wherein the step of removing includes removing the core from the candle body with the coring device to form a cavity in the candle body.

14. The method of claim 13 wherein the step of removing includes the coring device retaining the core from the candle body, and further comprising the step of determining a depth of the cavity formed in the candle body by the coring device with the plurality of measurement markers, wherein at least a portion of the coring device is transparent so that the core of the candle body is visible relative to the measurement markers.

15. The method of claim 13 wherein the step of removing includes the coring device retaining the core from the candle body, and further comprising the step of determining a depth of the cavity formed in the candle body by the coring device with the plurality of measurement markers, wherein at least a portion of the coring device is open so that the core of the candle body is visible relative to at least one of the measurement markers.

16. The method of claim 12 wherein the step of extending includes the coring device including a first coring member and a second coring member that fits substantially within and moves relative to the first coring member.

17. The method of claim 16 wherein the step of extending includes positioning a sealer substantially between the first coring member and the second coring member.

18. The method of claim 12 wherein the step of extending includes the candle body including a wick, and wherein the step of removing includes removing the core from the candle body with the coring device to form a cavity in the candle body that is substantially parallel to the wick.

19. The method of claim 12 wherein the step of extending includes the candle body including a wick, and wherein the step of removing includes removing the core from the candle body with the coring device to form a cavity in the candle body that is spaced apart from the wick in the candle body.

20. The method of claim 12 wherein the step of extending includes the candle body including a wick, and wherein the step of removing includes removing the core from the candle body with the coring device to form a cavity in the candle body that substantially encircles the wick in the candle body.
